(19) United States
(12) Patent Application Publication
(10) Pub. No.: US 2026/0149021 A1
(43) Pub. Date: May 28, 2026

(54) FUEL CELL

(71) Applicants: HYUNDAI MOTOR COMPANY, Seoul (KR); KIA CORPORATION, Seoul (KR)

(72) Inventor: Jee Hong Min, Hwaseong-si (KR)

(73) Assignees: HYUNDAI MOTOR COMPANY, Seoul (KR); KIA CORPORATION, Seoul (KR)

(21) Appl. No.: 19/222,308

(22) Filed: May 29, 2025

(30) Foreign Application Priority Data
Nov. 28, 2024 (KR) 10-2024-0173829

(51) Int. Cl. H01M 8/2404; H01M 8/00; H01M 8/248; H01M 8/249

(52) U.S. Cl. CPC H01M 8/2404; H01M 8/002; H01M 8/248; H01M 8/249

(57) ABSTRACT

A fuel cell includes a cell stack including a plurality of unit cells stacked in a first direction; a first end plate disposed on a first end of the cell stack; a second end plate disposed on a second end of the cell stack; a fastening bar fastened to at least one of the first end plate or the second end plate; and a housing coupled to the first and second end plates so as to surround the cell stack at a position outside the fastening bar. The cell stack includes a side portion having an accommodation groove formed therein by recessed portions included in the plurality of unit cells so as to extend in the first direction, and at least a portion of the fastening bar is disposed in the accommodation groove.

### CROSS-REFERENCE TO RELATED APPLICATION

This application claims priority to and the benefit of Korean Patent Application No. 10-2024-0173829, filed on Nov. 28, 2024, the entire of which is hereby incorporated by reference.

### TECHNICAL FIELD

The present disclose relates to a fuel cell.

### BACKGROUND

A fuel cell is a power generation device that is capable of producing electricity through a chemical reaction of fuel using a catalyst. Such a fuel cell is utilized as a power supply device in various fields.

Examples of materials used as fuel include hydrogen, hydrocarbons, and hydrocarbon compounds. Among these materials, hydrogen reacts with oxygen to generate water, thermal energy, and electrical energy.

In general, a fuel cell includes a unit cell composed of a membrane electrode assembly (MEA), which includes an oxidation electrode (fuel electrode, hydrogen electrode, or anode) in which hydrogen is oxidized, a reduction electrode (air electrode, oxygen electrode, or cathode) to which oxygen is supplied and in which a reduction reaction occurs, and a polymer electrolyte membrane through which hydrogen ions are transported between the oxidation electrode and the reduction electrode.

The output voltage of a unit cell is only 0.6 V to 1 V. Thus, unit cells are stacked in series in order to obtain practical output, and a set of stacked cells is called a cell stack.

Such a cell stack requires a fastening device to fix unit cells. In order to securely make the cell stack airtight, the unit cells need to be compressed with a certain surface pressure. To this end, both ends of the cell stack are pressed by end plates, which are rigid objects, and a fastening bar is assembled in a state in which the cell stack is compressed by the end plates, thereby fixing the unit cells so that the length of the cell stack does not increase. A combination of the cell stack, the end plates, and the fastening bar may be referred to as a “stack module” for convenience of description. A fuel cell includes a structure in which a plurality of stack modules is stacked and coupled in order to generate a larger amount of energy.

The statements in this Background section merely provide background information related to the present disclosure and may not constitute prior art.

### SUMMARY

Various aspects of the present disclosure provide a fuel cell that substantially obviates one or more problems due to limitations and disadvantages of the related art.

Various aspects of the present disclosure provide a fuel cell having an improved structure in which a fastening bar is fastened to an end plate and unit cells are directly stacked on the end plate, whereby a multi-stage stack module is established without stacking a plurality of stack modules.

In addition, Various aspects of the present disclosure provide a fuel cell having a structure in which current collecting terminals are embedded in end plates, thereby allowing all electrical parts to be provided in a housing.

However, the objects to be accomplished by various aspects of the present disclosure are not limited to the above-mentioned objects, and other objects not mentioned herein should be clearly understood by those having ordinary skill in the art from the following description.

Additional advantages, objects, and features of the disclosure are set forth in part in the description which follows and in part should become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to an embodiment of the present disclosure, a fuel cell may include: at least one cell stack including a plurality of unit cells stacked in a first direction; a first end plate disposed on a first end of the cell stack; a second end plate disposed on a second end of the at least one cell stack; at least one fastening bar fastened to at least one of the first end plate or the second end plate; and a housing coupled to the first end plate and second end plate and surrounding the cell stack at a position outside the fastening bar. The at least one cell stack may include a side portion having an accommodation groove formed by recessed portions included in the plurality of unit cells and extending in the first direction. At least a portion of the at least one fastening bar may be disposed in the accommodation groove.

In an embodiment, the at least one fastening bar may have a cross-sectional shape corresponding to the cross-sectional shape of the recessed portions.

In an embodiment, the at least one fastening bar may include a plurality of fastening bars, and among the plurality of fastening bars, a fastening bar located at a corner of the at least one cell stack may include a protection portion configured to cover the corner of the at least one cell stack.

In an embodiment, the housing may be coupled to at least a portion of the at least one fastening bar in a direction perpendicular to the first direction.

In an embodiment, the at least one cell stack may include a plurality of cell stacks disposed in a direction perpendicular to the first direction

In an embodiment, the accommodation groove in each cell stack of the plurality of cell stacks may include an outer accommodation groove formed in an outer side portion of each cell stack of the plurality of cell stacks facing the housing and an inner accommodation groove formed in an inner side portion of each cell stack of the plurality of cell stacks facing a neighboring cell stack.

In an embodiment, the at least one fastening bar may include at least one first fastening bar disposed in the outer accommodation groove and at least one second fastening bar disposed in the inner accommodation groove.

In an embodiment, the at least one second fastening bar may include a plurality of second fastening bars, and the fuel cell may further include an alignment bar disposed between the plurality of second fastening bars and extended in the first direction between the first end plate and the second end plate.

In an embodiment, the thickness of the alignment bar in a second direction may be equal to or greater than the maximum interval or greatest interval between a cell stack of the plurality of cell stacks and an adjacent cell stack of the plurality of cell stacks.

In an embodiment, the alignment bar may include an end portion coupled to at least one of the first end plate or the second end plate and another end portion having a tapered cross-sectional shape.

In an embodiment, the fuel cell may further include: a first current collector disposed between one of the first end or the second end of the at least one cell stack and the first end plate; a second current collector disposed between the other of the first end or the second end of the at least one cell stack and the second end plate; a first current collecting terminal electrically connected to the first current collector and embedded in the first end plate; and a second current collecting terminal electrically connected to the second current collector and embedded in the second end plate.

In an embodiment, the first end plate may include a first body and a first protruding portion protruding from the first body toward the at least one cell stack. The second end plate may include a second body and a second protruding portion protruding from the second body toward the at least one cell stack. The first current collecting terminal may be embedded in the first protruding portion, and the second current collecting terminal may be embedded in the second protruding portion.

In an embodiment, the housing may be coupled at both ends thereof to the first body and the second body (e.g., the housing may have a first housing end and a second housing end respectively coupled to the first body and the second body) and surround a side portion of the at least one cell stack. The fuel cell may further include a bus bar disposed in the housing so as to interconnect the first current collecting terminal and the second current collecting terminal.

In an embodiment, the protruding thickness of at least one of the first protruding portion or the second protruding portion may be determined depending on or based on the internal pressure of the at least one cell stack.

In an embodiment, the first current collecting terminal connected to the bus bar may be connected to one cell stack of the plurality of cell stacks, and the second current collecting terminal connected to the bus bar may be connected to another cell stack of the plurality of cell stacks.

According to an embodiment of the present disclosure, a method of manufacturing the fuel cell configured as described above may include: fastening the at least one fastening bar to the first end plate; stacking the plurality of cell stacks on an inner side of the first end plate; coupling the alignment bar to the second end plate; and coupling the second end plate to the fastening bar while inserting the alignment bar into an area between the plurality of cell stacks.

According to another embodiment of the present disclosure, a fuel cell may include: at least one cell stack including a plurality of unit cells stacked in a first direction; a first end plate disposed on a first end of the at least one cell stack; a second end plate disposed on a second end of the at least one cell stack; at least one fastening bar fastened to the first end plate and the second end plate; a first current collector disposed between one of first end or second end of the at least one cell stack and the first end plate; a second current collector disposed between the other of the first end or the second end of the at least one cell stack and the second end plate; a first current collecting terminal electrically connected to the first current collector and embedded in the first end plate; and a second current collecting terminal electrically connected to the second current collector and embedded in the second end plate. The at least one cell stack may include a side portion having an accommodation groove formed by recessed portions included in the plurality of unit cells and extending in the first direction, and at least a portion of the at least one fastening bar may be disposed in the accommodation groove.

In an embodiment, the at least one cell stack may include a plurality of cell stacks disposed in a direction perpendicular to the first direction. The accommodation groove in each cell stack of the plurality of cell stacks may include: an outer accommodation groove formed in an outer side portion of each cell stack of the plurality of cell stacks; and an inner accommodation groove formed in an inner side portion of each cell stack of the plurality of cell stacks facing a neighboring cell stack. The at least one fastening bar may include: at least one first fastening bar disposed in the outer accommodation groove; and at least one second fastening bar disposed in the inner accommodation groove.

In an embodiment, the fastening bar may be provided in plural, and among the plurality of fastening bars, a fastening bar located at a corner of the at least one cell stack may include a protection portion formed so as to cover or configured to cover the corner of the at least one cell stack.

In an embodiment, the at least one second fastening bar may include a plurality of second fastening bars, and the fuel cell may further include an alignment bar disposed between the second fastening bars and extending in the first direction between the first end plate and the second end plate. The alignment bar may include: an end portion coupled to at least one of the first end plate or the second end plate; and another end portion having a tapered cross-sectional shape. The cell stack may be provided in plural, and the thickness of the alignment bar in a second direction may be equal to or greater than the maximum interval (or the greatest interval) between one cell stack of the plurality of cell stacks and an adjacent cell stack of the plurality of cell stacks.

In an embodiment, the first end plate may include a first body and a first protruding portion protruding from the first body toward the at least one cell stack. The second end plate may include a second body and a second protruding portion protruding from the second body toward the at least one cell stack. The first current collecting terminal may be embedded in the first protruding portion, and the second current collecting terminal may be embedded in the second protruding portion.

In an embodiment, the fuel cell may further include a bus bar interconnecting the first current collecting terminal and the second current collecting terminal. The first current collecting terminal connected to the bus bar may be connected to one of the plurality of cell stacks, and the second current collecting terminal connected to the bus bar may be connected to another of the plurality of cell stacks. The bus bar may connect the first current collecting terminal connected to one cell stack of the plurality of cell stacks, and the second current collecting terminal connected to another cell stack of the plurality of cell stacks

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a perspective view of a fuel cell according to an embodiment of the present disclosure;

FIG. 2 is a perspective view of the fuel cell shown in FIG. 1, with a housing removed;

FIG. 3A is a side view of a fuel cell showing a process for coupling cell stacks and a second end plate to a first end plate, and FIG. 3B is side view of a fuel cell showing a state in which the first end plate, the cell stacks, and the second end plate are coupled to each other, when viewed in a y-axis direction according to one or more embodiments of the present disclosure;

FIGS. 4A and 4B are views showing a first end plate or a second end plate according to an embodiment of the present disclosure;

FIG. 5 is a perspective view showing a state in which a second end plate and alignment bars are coupled to each other according to an embodiment of the present disclosure;

FIG. 6 is a view showing a process of manufacturing a fuel cell according to an embodiment of the present disclosure;

FIGS. 7A and 7B are views showing a cross-section B shown in the drawing corresponding to S104 in FIG. 6;

FIG. 8 is a view showing enlarged cross-sectional views of a portion D in FIG. 7B, wherein a left drawing is a view showing a state before the alignment bar is inserted, and a right drawing is a view showing a state after the alignment bar is inserted;

FIG. 9 shows a process of aligning cell stacks with cross-sectional views taken along line E-E′ in FIG. 8;

FIG. 10 illustrates a front view and a rear view of the perspective view (perspective view F) of the fuel cell shown in FIG. 2;

FIG. 11A illustrates an exploded front view of a fuel cell and FIG. 11B illustrates a coupled front view of a fuel cell according to a first comparative example; and

FIG. 12 is a view showing the structures of current collecting terminals and fuel cells according to the first and second comparative examples and an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings so that those having ordinary skill in the art can easily carry out embodiments. The present disclosure may, however, be embodied in many different forms, and should not be construed as being limited to embodiments set forth herein. In the drawings, parts irrelevant to description of the present disclosure have been omitted for clarity. Like reference numerals refer to like elements throughout the specification.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It should be further understood that the term “comprise,” “include,” or “have”, when used herein, specifies the presence of stated features, integers, steps, operations, elements, components, or combinations thereof, but does not preclude the presence or addition of one or more other features, integers, steps, operations, elements, components, or combinations thereof.

The terms “—part”, “—unit”, and “—module” used in the specification mean units for processing at least one function or operation, and can be implemented as hardware, software, or combinations of hardware and software.

Although terms including ordinal numbers, such as “first”, “second”, and the like, may be used herein to describe various elements, the elements are not limited by these terms. The terms may be used only as denominative meanings to distinguish one element from another, and sequential meanings thereof are determined not by names, but by context of the corresponding description.

The term “and/or” is used to include any combination of a plurality of items that are the subject matter. For example, “A and/or B” inclusively means all three cases such as “A”, “B”, and “A and B”. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

When a component, device, element, apparatus, or the like of the present disclosure is described as having a purpose or performing an operation, function, or the like, the component, device, element, apparatus, or the like should be considered herein as being “configured to” meet that purpose or to perform that operation or function.

When an element is referred to as being “connected” or “coupled” to another element, the element may be directly connected or coupled to the other element. However, it should be understood that another element may be present therebetween.

Unless otherwise defined, all terms used herein, which include technical or scientific terms, have the same meanings as those generally appreciated by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, a fuel cell 10 according to an embodiment is described with reference to the accompanying drawings.

The fuel cell 10 is described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but embodiments are not limited thereto. In other words, the x-axis, the y-axis, and the z-axis may intersect each other obliquely.

The x-axis direction may be a concept including both the +x-axis direction and the −x-axis direction, the y-axis direction may be a concept including both the +y-axis direction and the −y-axis direction, and the z-axis direction may be a concept including both the +z-axis direction and the −z-axis direction.

In an embodiment, the x-axis direction may be a direction in which a cell stack 300 is stacked. The y-axis direction and the z-axis direction may be directions perpendicular to the x-axis direction. The z-axis direction may be a direction in which a plurality of cell stacks 300 is disposed in an embodiment of the present disclosure. The y-axis direction may be a direction perpendicular to both the x-axis direction and the z-axis direction or may be a direction in which a plurality of alignment bars 250 or a plurality of fastening bars 150 is disposed.

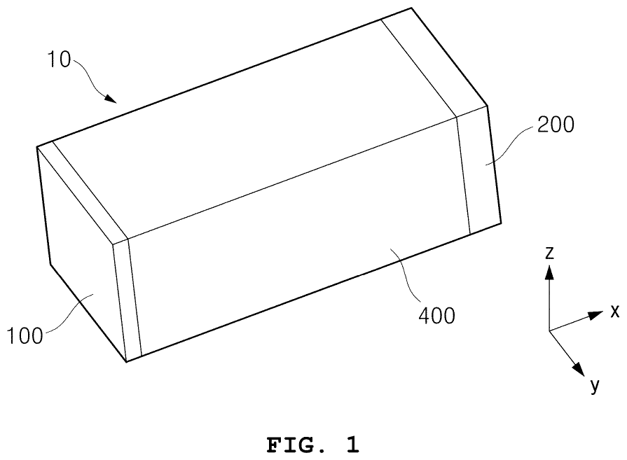

Hereinafter, the configuration of a fuel cell 10 according to an embodiment of the present disclosure is described with reference to FIGS. 1 to 5.

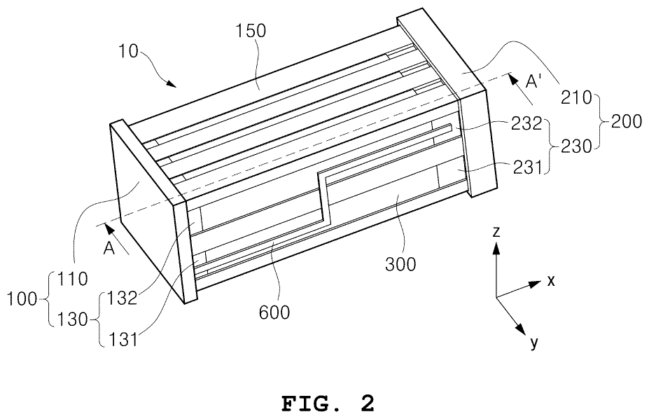

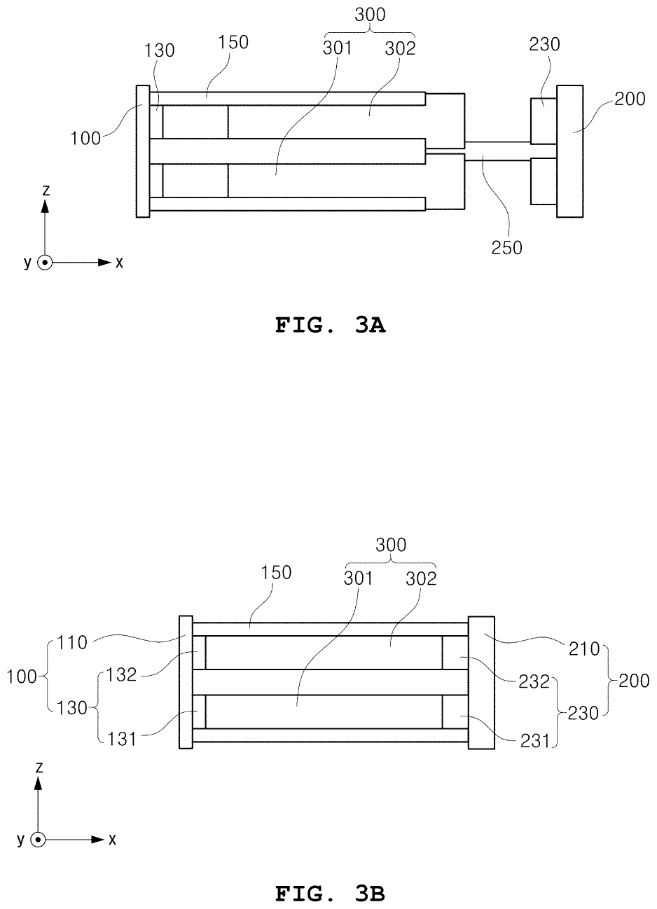

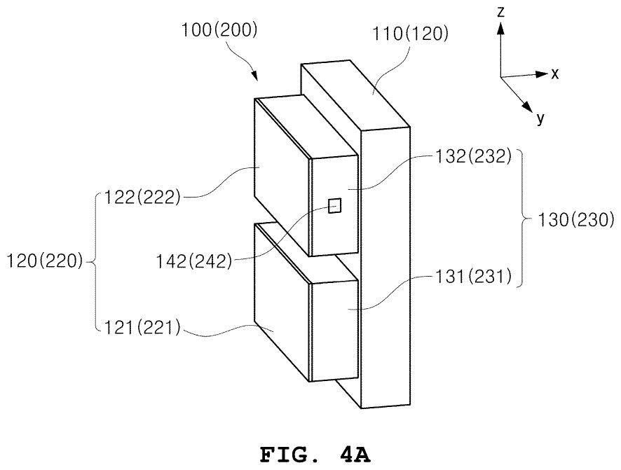

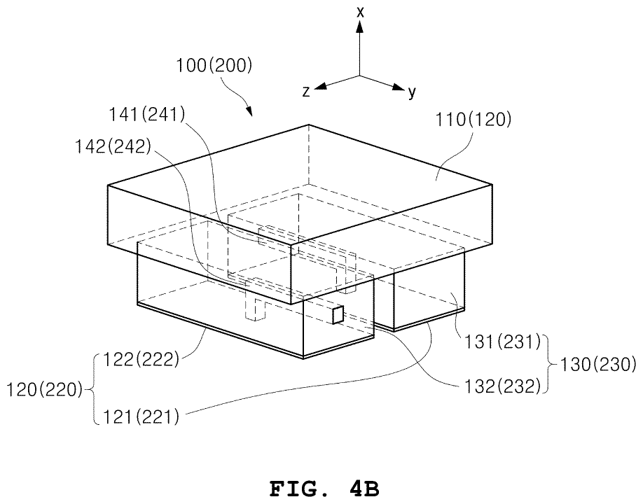

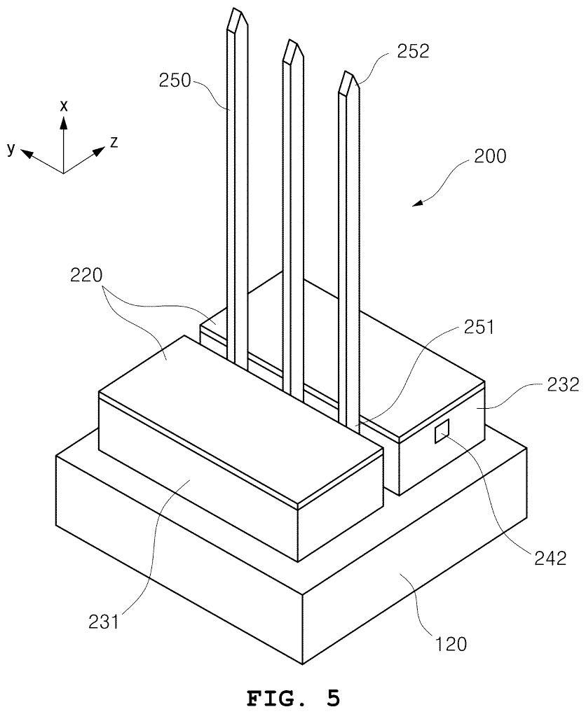

FIG. 1 is a coupled perspective view of a fuel cell 10 according to an embodiment of the present disclosure, FIG. 2 is a coupled perspective view of the fuel cell 10 shown in FIG. 1, with a housing 400 removed, and FIGS. 3A and 3B are side view of the fuel cell 10 shown in FIG. 2 when viewed in the y-axis direction (in a direction indicated by arrows A and A′). FIG. 3A is a view showing a process in which cell stacks 300 and a second end plate 200 are coupled to a first end plate 100, and FIG. 3B is a view showing a state in which the first end plate 100, the cell stacks 300, and the second end plate 200 are completely coupled to each other. FIGS. 4A and 4B are views showing the first end plate 100 or the second end plate 200. FIG. 5 is a perspective view showing a state in which the second end plate 200 and alignment bars 250 according to an embodiment of the present disclosure are coupled to each other.

Referring to FIGS. 1 and 2, a fuel cell 10 according to an embodiment of the present disclosure includes a cell stack 300, a first end plate 100, and a second end plate 200, and includes a housing 400, a fastening bar 150, and a bus bar 600, which are disposed between the first end plate 100 and the second end plate 200.

The cell stack 300 is configured such that a plurality of unit cells is stacked in the x-axis direction. The cell stack 300 according to an embodiment of the present disclosure may be provided singularly or in plural. A plurality of cell stacks 300 may be disposed in the y-axis direction or the z-axis direction or may be disposed in both the y-axis direction and the z-axis direction. The number of cell stacks 300 may be two or greater. According to an embodiment of the present disclosure, it is illustrated in the drawings that two cell stacks 300 are disposed in the z-axis direction.

The first end plate 100 and the second end plate 200 are disposed on outer sides of both ends of each of the cell stacks 300 (e.g., outer sides in the vertical direction or outer sides in the x-axis direction), and the housing 400 is disposed on outer sides of the cell stacks 300 in the horizontal direction (or outer sides in a direction perpendicular to the x-axis direction). The first end plate 100, the second end plate 200, and the housing 400 may serve to protect the cell stacks 300 from the surrounding environment.

The fastening bar 150 is a structural device for preventing the cell stacks 300 in a pressed state from being restored due to reaction force in order to securely make the cells airtight. Both ends of the fastening bar 150 may be coupled to the first end plate 100 and the second end plate 200, respectively. In the present disclosure, the fastening bar 150 may also serve to guide stacking of a plurality of unit cells constituting the cell stacks 300. In addition, the fastening bar 150 may serve as an impact beam that protects the cells from lateral impact and fixes the cells.

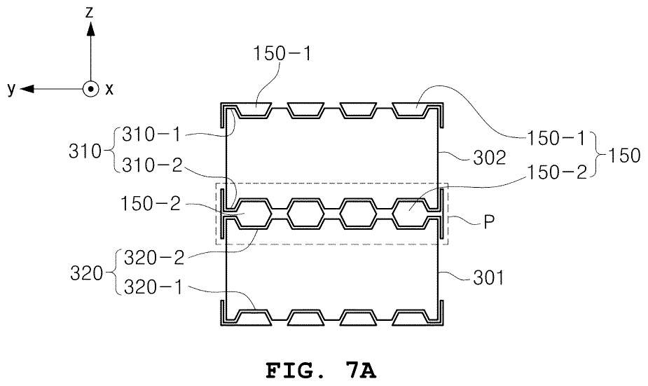

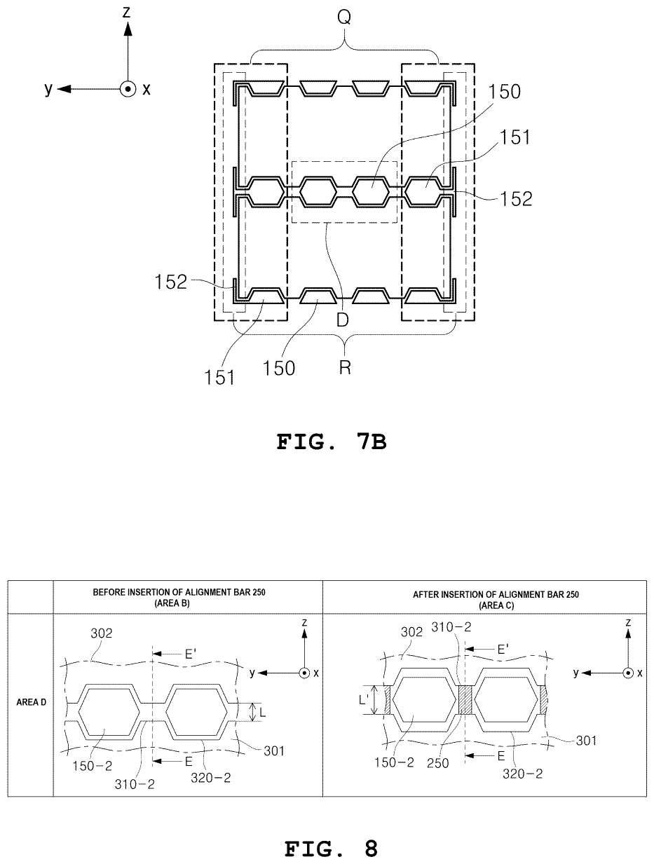

Referring to FIG. 3A, the fastening bar 150 may be fastened to the first end plate 100, and each of the cell stacks 300 may be stacked in the x-axis direction on the inner side of the first end plate 100. In this case, the fastening bar 150 may serve as a guide when the plurality of unit cells constituting the cell stacks 300 is stacked. Further, the cell stacks 300 may be primarily aligned and protected from external impact by the fastening bar 150. This is described in detail below with reference to FIGS. 7A and 7B.

Each of the first end plate 100 and the second end plate 200 includes a body, a protruding portion, a current collector, and a current collecting terminal. These common constituent elements of the first end plate 100 and the second end plate 200 are shown in FIGS. 4A and 4B. In FIGS. 4A and 4B, reference numerals outside the parentheses designate the constituent elements of the first end plate 100, and reference numerals inside the parentheses designate the constituent elements of the second end plate 200. Considering the orientation of the end plate shown in FIG. 4A, the end plate shown in FIG. 4A may correspond to the second end plate 200 of the fuel cell 10 shown in FIG. 2. In this case, the end plate obtained by flipping the end plate shown in FIG. 4A 180 degrees with respect to the y-z plane may correspond to the first end plate 100 of the fuel cell 100 shown in FIG. 2.

The first end plate 100 includes a first body 110 and a first protruding portion 130 protruding from the first body 110 toward the cell stacks 300, and the second end plate 200 includes a second body 210 and a second protruding portion 230 protruding from the second body 210 toward the cell stacks 300.

The number of each of the first protruding portion 130 and the second protruding portion 230 may correspond to the number of cell stacks 300 included in the fuel cell 10. As described above, because an embodiment illustrated in the drawings includes two cell stacks 300 disposed in the z-axis direction, the first protruding portion 130 may include a 1-1^{st} protruding portion 131 and 1-2^{nd} protruding portion 132 disposed in the z-axis direction, and the second protruding portion 230 may include a 2-1^{st} protruding portion 231 and a 2-2^{nd} protruding portion 232 disposed in the z-axis direction.

In addition, the first end plate 100 and the second end plate 200 may include current collectors disposed between respective protruding portions and the cell stacks 300 corresponding thereto. The current collectors serve to collect electrons that the cell stacks 300 generate while producing electricity. Therefore, the current collectors may be disposed on both ends of each of the cell stacks 300.

The current collectors may include a first current collector 120 disposed between one end of each of the cell stacks 300 and the first protruding portion 130 and a second current collector 220 disposed between the other end of each of the cell stacks 300 and the second protruding portion 230.

The first current collector 120 included in the first end plate 100 may include a 1-1^{st} current collector 121 disposed between the 1-1^{st} protruding portion 131 and a first cell stack 301 and a 1-2^{nd} current collector 122 disposed between the 1-2^{nd} protruding portion 132 and a second cell stack 302, and the second current collector 220 included in the second end plate 200 may include a 2-1^{st} current collector 221 disposed between the 2-1^{st} protruding portion 231 and the first cell stack 301 and a 2-2^{nd} current collector 222 disposed between the 2-2^{nd} protruding portion 232 and the second cell stack 302.

In addition, according to an embodiment of the present disclosure, as shown in FIG. 4B, the first end plate 100 may include current collecting terminals 141 and 142 connected to the first current collector 120, and the second end plate 200 may include current collecting terminals 241 and 242 connected to the second current collector 220.

Each of the current collecting terminals may be disposed so as to be embedded in a corresponding one of the protruding portions. In detail, the 1-1^{st} current collecting terminal 141 connected to the 1-1^{st} current collector 121 may be embedded in the 1-1^{st} protruding portion 131, the 1-2^{nd} current collecting terminal 142 connected to the 1-2^{nd} current collector 122 may be embedded in the 1-2^{nd} protruding portion 132, the 2-1^{st} current collecting terminal 241 connected to the 2-1^{st} current collector 221 may be embedded in the 2-1^{st} protruding portion 231, and the 2-2^{nd} current collecting terminal 242 connected to the 2-2^{nd} current collector 222 may be embedded in the 2-2^{nd} protruding portion 232.

In this case, the 1-1^{st} current collecting terminal 141 and the 1-2^{nd} current collecting terminal 142 included in the first end plate 100 may be formed in a direction perpendicular to the stack placement direction (in the y-axis direction) so as to extend in opposite directions. In other words, the 1-1^{st} current collecting terminal 141 may be disposed so as to be exposed from one side surface of the 1-1^{st} protruding portion 131, and the 1-2^{nd} current collecting terminal 142 may be disposed so as to be exposed from one side surface of the 1-2^{nd} protruding portion 132 that faces in a direction opposite the direction in which the side surface of the 1-1^{st} protruding portion 131 faces. This configuration is similarly applied to the second end plate 200. The 2-1^{st} current collecting terminal 241 and the 2-2^{nd} current collecting terminal 242 may be formed in a direction perpendicular to the stack placement direction (in the y-axis direction) so as to extend in opposite directions. In other words, the 2-1^{st} current collecting terminal 241 may be disposed so as to be exposed from one side surface of the 2-1^{st} protruding portion 231, and the 2-2^{nd} current collecting terminal 242 may be disposed so as to be exposed from one side surface of the 2-2^{nd} protruding portion 232 that faces in a direction opposite the direction in which the side surface of the 2-1^{st} protruding portion 231 faces.

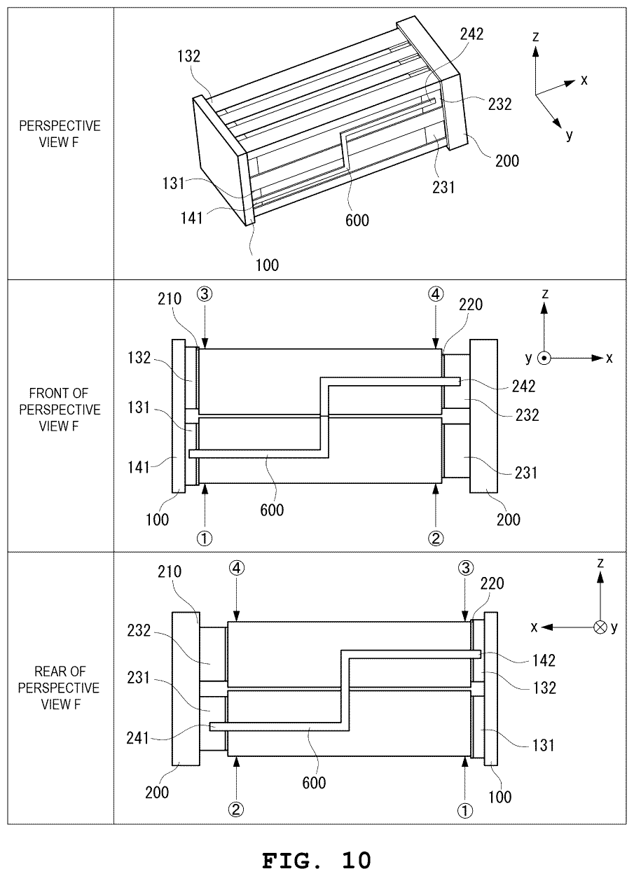

The bus bar 600 may electrically interconnect the current collecting terminals 141 and 142 of the first end plate 100 and the current collecting terminals 241 and 242 of the second end plate 200. The bus bar 600 may interconnect the 1-1^{st} current collecting terminal 141 and the 2-2^{nd} current collecting terminal 242 and may interconnect the 1-2^{nd} current collecting terminal 142 and the 2-1^{st} current collecting terminal 241. This is merely given by way of example, and the disclosure is not necessarily limited thereto. A detailed description related thereto is given below with reference to FIG. 10.

In the case of including a plurality of cell stacks 300, the fuel cell 10 may further include an alignment bar 250 that is disposed between the plurality of cell stacks 300 to align the respective unit cells. As shown in FIG. 5, one end portion 251 of the alignment bar 250 is coupled to the second end plate 200 and is disposed between the 2-1^{st} protruding portion 231 and the 2-2^{nd} protruding portion 232 of the second end plate 200. In addition, the alignment bar 250 may include another end portion 252 extending in the x-axis direction so as to be located between the 1-1^{st} protruding portion 131 and the 1-2^{nd} protruding portion 132 of the first end plate 100.

However, this is merely given by way of example. Alternatively, the alignment bar 250 may include an end portion 251 coupled to the first end plate 100 between the 1-1^{st} protruding portion 131 and the 1-2^{nd} protruding portion 132 of the first end plate 100 and another end portion 252 located between the 2-1^{st} protruding portion 231 and the 2-2^{nd} protruding portion 232 of the second end plate 200.

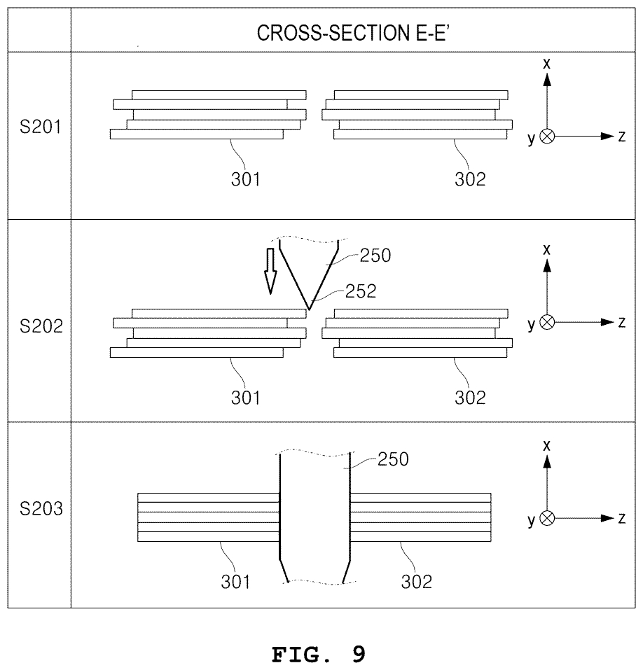

In addition, the other end portion 252 of the alignment bar 250 may include a tapered cross-sectional shape. The tapered cross-sectional shape may be located in the x-z plane. As shown in FIG. 3A, when the second end plate 200 is coupled, the alignment bar 250 may be inserted between the first cell stack 301 and the second cell stack 302. In this case, the tapered cross-sectional shape may be inserted between the first cell stack 301 and the second cell stack 302 while pushing and aligning the plurality of unit cells constituting the first cell stack 301 and the second cell stack 302. This is described in detail below with reference to FIG. 9.

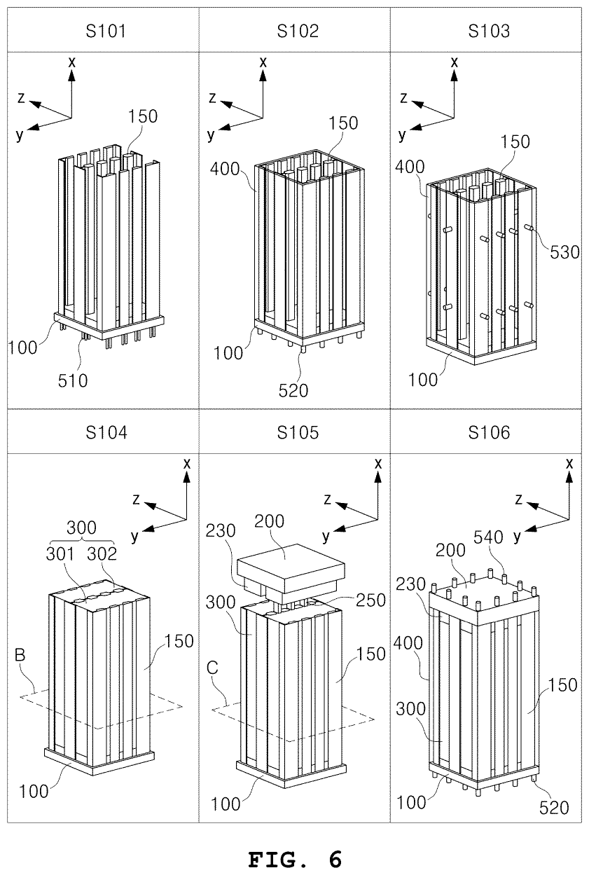

Hereinafter, a process of manufacturing the fuel cell 10 according to an embodiment of the present disclosure is described with reference to FIG. 6.

First, the first end plate 100 and the fastening bar 150 are fastened to each other by a first bolt 510 in the x-axis direction (S101). In this case, the fastening bar 150 may be disposed outside the first protruding portion 130. Thereafter, the housing 400 may be coupled to the first body 110 of the first end plate 100 by a second bolt 520 (S102 ). The housing 400 may be disposed outside the fastening bar 150. Thereafter, the fastening bar 150 facing the housing 400 may be fastened to the housing 400 by a third bolt 530 in a direction perpendicular to the x-axis direction (S103). Accordingly, the fastening bar 150 extending in the x-axis direction may be prevented from being bent at a distal end thereof, and may be kept perpendicular to the first end plate 100.

Thereafter, a plurality of unit cells may be stacked above the 1-1^{st} current collecting terminal 141 in the 1-1^{st} protruding portion 131 and the 1-2^{nd} current collecting terminal 142 in the 1-2^{nd} protruding portion 132 of the first end plate 100 (in the x-axis direction) (S104). For better understanding, illustration of the housing 400 is omitted in the drawings corresponding to S104 and S105. The cell stack 300 stacked above the 1-1^{st} current collecting terminal 141 may be referred to as the first cell stack 301, and the cell stack 300 stacked above the 1-2^{nd} current collecting terminal 142 may be referred to as the second cell stack 302.

Due to the coupling structure of the first end plate 100 and the fastening bar 150, the plurality of unit cells constituting the first cell stack 301 and the second cell stack 302 may be directly and simultaneously stacked on the first end plate 100. Accordingly, a plurality of stack modules does not need to be stacked, whereby the number of steps of the manufacturing process may be reduced, and the risk of injury caused by transportation of heavy parts (e.g., the cell stacks 300) may be reduced.

In this case, when the plurality of unit cells is stacked, the plurality of unit cells may be guided by recessed portions included in the cells and the fastening bar 150. This is described with reference to FIGS. 7A and 7B each showing a cross-section B shown in the drawing corresponding to S104 in FIG. 6.

As shown in FIGS. 7A and 7B, each of the unit cells may include a recessed portion formed in a side portion 310 thereof. The side portion 310 may be a portion corresponding to a side surface of each unit cell when the surfaces of each unit cell that face in the stacking direction are defined as upper and lower surfaces. In an embodiment shown in FIGS. 7A and 7B, the cross-section of the recessed portion may have a shape similar to half a hexagon or may have a U-shape or a V-shape.

As the plurality of unit cells is stacked, the recessed portions in the side portions 310 of the unit cells may form an accommodation groove 320 in the side portion 310 of the cell stack 300. Because the unit cells are stacked in the x-axis direction, the accommodation groove 320 may extend in the x-axis direction.

The cross-section of the fastening bar 150 cut in a direction perpendicular to the x-axis direction may have a shape corresponding to the recessed portion in the cell stack 300. Therefore, as shown in FIGS. 7A and 7B, the cross-section of the fastening bar 150 cut in a direction perpendicular to the x-axis direction may have a shape similar to half a hexagon or may have a U-shape or a V-shape. However, the cross-section of the fastening bar 150 may have a smaller size than the cross-section of the recessed portion in the unit cell.

Because the cross-sectional shape of the fastening bar 150 and the cross-sectional shape of the recessed portion in the unit cell correspond to each other, when the unit cells are stacked, the unit cells may be guided and primarily aligned by the fastening bar 150. At least a portion of the fastening bar 150 may be accommodated in the accommodation groove 320 in the side portion 310 of the cell stack 300 formed by stacking the unit cells.

As shown in FIG. 7A, if the cell stack 300 is provided in plural, the side portion 310 of each of the plurality of cell stacks 300 may be divided into an outer side portion 310-1 facing the housing 400 and an inner side portion 310-2 facing the neighboring cell stack 300. In this case, the accommodation groove 320 may include an outer accommodation groove 320-1 formed in the outer side portion 310-1 and an inner accommodation groove 320-2 formed in the inner side portion 310-2. In addition, the fastening bar 150 may include a first fastening bar 150-1 disposed in the outer accommodation groove 320-1 and a second fastening bar 150-2 disposed in the inner accommodation groove 320-2.

The side portion 310, the accommodation groove 320, and the fastening bar 150 located in an area P shown in FIG. 7A correspond to the inner side portion 310-2, the inner accommodation groove 320-2, and the second fastening bar 150-2, respectively, and the side portion 310, the accommodation groove 320, and the fastening bar 150 located outside the area P correspond to the outer side portion 310-1, the outer accommodation groove 320-1, and the first fastening bar 150-1, respectively. If the cell stack 300 is provided singularly, the fuel cell may have a configuration excluding the area P.

The fastening bar 150 may be in contact with the respective unit cells. Thus, if the fastening bar 150 is made of metal, the fastening bar 150 may conduct electricity between the unit cells. Therefore, it is necessary to perform insulation processing, e.g., coating processing or insert injection molding, on the fastening bar 150. If the cell stack 300 is provided in plural, an insulation interval may be secured between the plurality of cell stacks 300 due to the second fastening bar 150-2 located on the surfaces of the cell stacks 300 that face each other. In other words, the second fastening bar 150-2 may serve as an insulating plate between the cell stacks 300 adjacent to each other.

The fastening bar 150 may be provided in plural, and a fastening bar 151 located at the corner of the cell stack 300, among the plurality of fastening bars 150, may include a protection portion 152 formed so as to cover the corner of the cell stack 300. Referring to FIG. 7B, the fastening bar 150 located in an area Q corresponds to the fastening bar 151 located at the corner of the cell stack 300. Being located at the corner includes not only a case of being located exactly at the corner but also a case of being located as close to the corner as possible. The fastening bar 151 located at the corner of the cell stack 300 may include a protection portion 152, as indicated by the area R. The protection portion 152 may be formed to cover and fix the corner of the cell stack 300, thereby preventing the cells from escaping outside due to external impact.

Referring again to FIG. 6, after the unit cells are stacked on the first end plate 100 (S104), the second end plate 200, to which the alignment bar 250 is coupled as shown in FIG. 5, is coupled (S105).

The second end plate 200 may be coupled in the x-axis direction while pressing the cell stacks 300 until the second body 210 comes into contact with the other end of the housing 400 or the fastening bar 150.

In other words, both ends of the housing 400, illustration of which is omitted in the drawing corresponding to S105 in FIG. 6, may be coupled to the first body 110 of the first end plate 100 and the second body 210 of the second end plate 200, respectively. Thus, the cell stacks 300 may be pressed by the first protruding portion 130 and the second protruding portion 230. The degree of pressing the cell stacks 300 may be adjusted by the thicknesses of the first protruding portion 130 and the second protruding portion 230 in the x-axis direction, and a target pressing amount may be determined depending on the internal pressure of the cell stacks 300. Therefore, the protruding thickness of at least one of the first protruding portion 130 or the second protruding portion 230 may be determined depending on the internal pressure of the cell stacks 300.

The alignment bar 250 and the second end plate 200 may not be necessarily coupled to each other in step S105, but may be coupled to each other in any one of the previous steps. The alignment bar 250 may extend in the x-axis direction between the first end plate 100 and the second end plate 200, and the other end portion 252 of the alignment bar 250 may reach an area between the 1-1^{st} protruding portion 131 and the 1-2^{nd} protruding portion 132.

Hereinafter, the alignment bar 250 is described with reference to FIG. 8. FIG. 8 is an enlarged cross-sectional view of a portion D in FIG. 7B. The left drawing in FIG. 8 is a view showing a state before the alignment bar 250 is inserted (i.e., area B in the drawing corresponding to S104 in FIG. 6), and the right drawing in FIG. 8 is a view showing a state after the alignment bar 250 is inserted (i.e., area C in the drawing corresponding to S105 in FIG. 6). Referring to FIG. 8, the alignment bar 250 may extend in the x-axis direction, may be disposed between the first cell stack 301 and the second cell stack 302 in the z-axis direction, and may be disposed between neighboring second fastening bars 150-2 in the y-axis direction.

The alignment bar 250 may be formed of a nonmetallic material (e.g., plastic), thereby blocking contact between the cells and thus preventing the occurrence of short circuit. In addition, because the alignment bar 250 is disposed between neighboring second fastening bars 150-2 disposed between the cell stacks 300, the alignment bar 250 may serve as an insulating plate together with the fastening bar 150.

The thickness of the alignment bar 250 in the z-axis direction may be equal to or greater than the maximum interval between the cell stacks 300 adjacent to each other, i.e., the maximum interval between the first cell stack 301 and the second cell stack 302 in FIG. 8. Alternatively, the thickness of the alignment bar 250 in the z-axis direction may be equal to or greater than the maximum interval between the unit cells constituting the first cell stack 301 and the unit cells constituting the second cell stack 302. Thus, the interval between the cell stacks 300 adjacent to each other, i.e., the first cell stack 301 and the second cell stack 302, after insertion of the alignment bar 250 is greater than the interval therebetween before insertion of the alignment bar 250 (L<L′). In this way, as the alignment bar 250 is inserted between the cell stacks 300, the alignment bar 250 may finally align the unit cells in a row, and may increase the interval between the cell stacks 300, thereby securing an additional insulation interval between the cell stacks 300.

In FIG. 9, which shows a cross-section cut along line E-E′ in FIG. 8, the drawing corresponding to S201 is a view showing parts of the cell stacks 300 stacked in a state of being primarily aligned by the fastening bar 150 before insertion of the alignment bar 250. The cell stacks 300 are finally aligned through steps S202 and S203.

As shown in the drawing corresponding to S202, the other end portion 252 of the alignment bar 250 may have a tapered cross-section. As the other end portion 252 of the alignment bar 250 that has a tapered cross-section is inserted in the x-axis direction, the unit cells constituting the first cell stack 301 and the second cell stack 302 may move in the z-axis direction and may be located in the x-z plane so as to be aligned in a row when viewed in the x-axis direction. The other end portion 252 of the alignment bar 250 that has a tapered cross-section may push the unit cells in the z-axis direction when inserted, thereby finally aligning the first cell stack 301 and the second cell stack 302, as shown in the drawing corresponding to S203 in FIG. 9.

Referring again to FIG. 6, after the second body 210 of the second end plate 200 comes into contact with the housing 400 or the fastening bar 150, the second end plate 200 may be coupled to at least one of the housing 400 or the fastening bar 150 by a fourth bolt 540 in the x-axis direction (S106).

Because both ends of the housing 400 are coupled to the first end plate 100 and the second end plate 200 in the x-axis direction, respectively, and the side surface of the housing 400 and the fastening bar 150 are coupled to each other in a direction perpendicular to the x-axis direction, the cell stacks 300 surrounded by the first end plate 100, the second end plate 200, and the fastening bar 150 may be protected from external impact and the surrounding environment.

Because the fastening bar 150 is coupled at both ends thereof to the first end plate 100 and the second end plate 200, the fastening bar 150 may serve to fix the length of the pressed cell stack 300 in the x-axis direction. In addition, as described above, because the fastening bar 150 includes a cross-section having a shape corresponding to the cross-sectional shape of the accommodation groove 320 in the cell stack 300 (or the recessed portion in the unit cell), the fastening bar 150 may serve to primarily align the cells when the cells are stacked. In addition, the protection portion 152 of the fastening bar 151 located at the corner of the cell stack 300 may serve as an impact beam that protects the cells from external impact.

In the present disclosure, the term “first end plate 100” is only used to refer to an end plate on which a plurality of unit cells is stacked, and the term “second end plate 200” is only used to refer to an end plate that presses the stacked cell stacks 300. Therefore, the end plates constituting the fuel cell 10 should not be construed as being limited by the terms “first end plate 100” and “second end plate 200”. In other words, the fastening bar 150 may be coupled to the second end plate 200, and the plurality of unit cells may be stacked on the second end plate 200. In addition, the alignment bar 250 may be coupled to the first end plate 100, and the first end plate 100 may be assembled to a structure in which the second end plate 200, the fastening bar 150, and the cell stacks 300 are coupled to each other.

Hereinafter, the connection structure of the bus bar 600 of the fuel cell 10 of the present disclosure is described with reference to FIG. 10. FIG. 10 illustrates a front view and a rear view of the perspective view (perspective view F) of the fuel cell 10 shown in FIG. 2.

Referring to FIG. 10, in the first cell stack 301, a 1^{st} unit cell may be located at, and a plurality of unit cells may be stacked on the 1^{st} unit cell in the x-axis direction so that a 100^{th} unit cell is located at. Similarly, in the second cell stack 302, a 101^{st} unit cell may be located at, and a plurality of unit cells may be stacked on the 101^{st} unit cell in the x-axis direction so that a 200^{th} unit cell is located at. Assuming that each unit cell generates 1 volt of power, each of the first cell stack 301 and the second cell stack 302 may generate 100 volts of power. As shown in the front view, one bus bar 600 may interconnect the 1-1^{st} current collector 121 or the 1-1^{st} current collecting terminal 141 of the 1-1^{st} protruding portion 131 located adjacent to and the 2-2^{nd} current collector 222 or the 2-2^{nd} current collecting terminal 242 of the 2-2^{nd} protruding portion 232 located adjacent to, and as shown in the rear view, another bus bar 600 may interconnect the 2-1^{st} current collector 221 or the 2-1^{st} current collecting terminal 241 of the 2-1^{st} protruding portion 231 located adjacent to and the 1-2^{nd} current collector 122 or the 1-2^{nd} current collecting terminal 142 of the 1-2^{nd} protruding portion 132 located adjacent to. In this case, it is possible to obtain an effect of connecting the first cell stack 301 and the second cell stack 302, which are disposed in parallel, to each other in series. Accordingly, the fuel cell 10 shown in FIG. 10 may generate 200 volts of power. However, this is merely given by way of example, and the disclosure is not necessarily limited thereto. The structure of the bus bars 600 interconnecting the current collecting terminals may be determined depending on the number and positions of the cell stacks 300 included in the fuel cell 10.

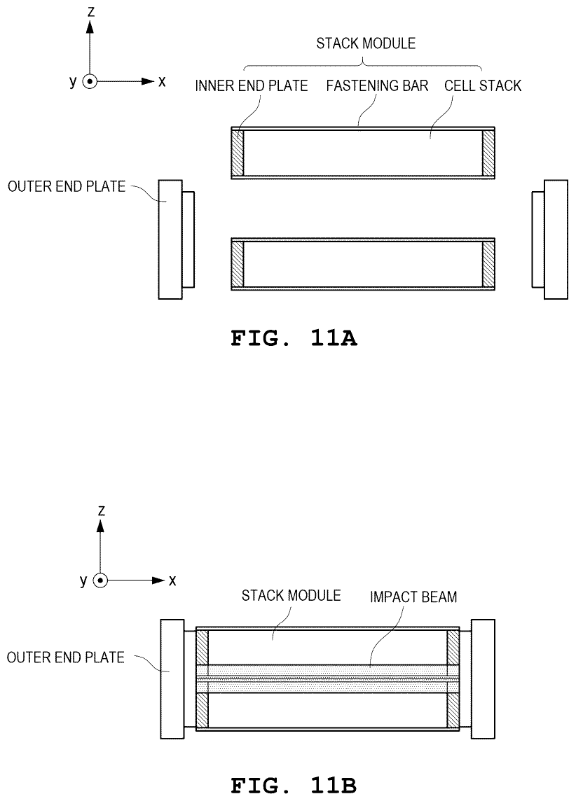

FIG. 11A is an exploded front view of a fuel cell according to a first comparative example, and FIG. 11B is a coupled front view of the fuel cell according to the first comparative example. As described above, the fuel cell according to the first comparative example is configured such that a plurality of stack modules, each of which includes a cell stack formed by stacking unit cells, inner end plates disposed on both sides of the cell stack, and a fastening bar interconnecting the two opposite inner end plates while pressing the cell stack, is stacked in the z-axis direction and outer end plates are coupled to both ends of the stack modules in order to support and fix the stack modules. In addition, an impact beam is disposed between the stack modules stacked in the z-axis direction and is coupled to the two opposite outer or inner end plates in the x-axis direction, thereby preventing the cells from escaping when the fuel cell receives impact from outside a vehicle.

In the fuel cell according to the first comparative example, the inner end plates are additionally required in proportion to the number of stack modules included in the fuel cell, and there is difficulty in manufacturing the fuel cell due to stacking of the stack modules, which are heavy, in a vertical direction.

In contrast, according to an embodiment of the present disclosure, the fastening bar is preferentially coupled to the first end plate, so that a plurality of unit cells is capable of being directly stacked on the first end plate and also being simultaneously stacked so as to form a plurality of cell stacks. Further, the fastening bar simultaneously performs functions of a cell alignment guide and an impact beam as well as the function of the fastening bar according to the first comparative example.

Compared to the first comparative example, according to an embodiment of the present disclosure, the number of end plates may be reduced (particularly, additional end plates are not required even when the number of cell stacks increases), and there is no need to have a separate cell alignment guide or impact beam, thereby reducing manufacturing costs through reduction in the number of parts and achieving a compact package. In addition, because it is not necessary to stack the stack modules, it is possible to reduce the risk of injury caused by stacking the stack modules, which are heavy, and to reduce the number of steps of the manufacturing process.

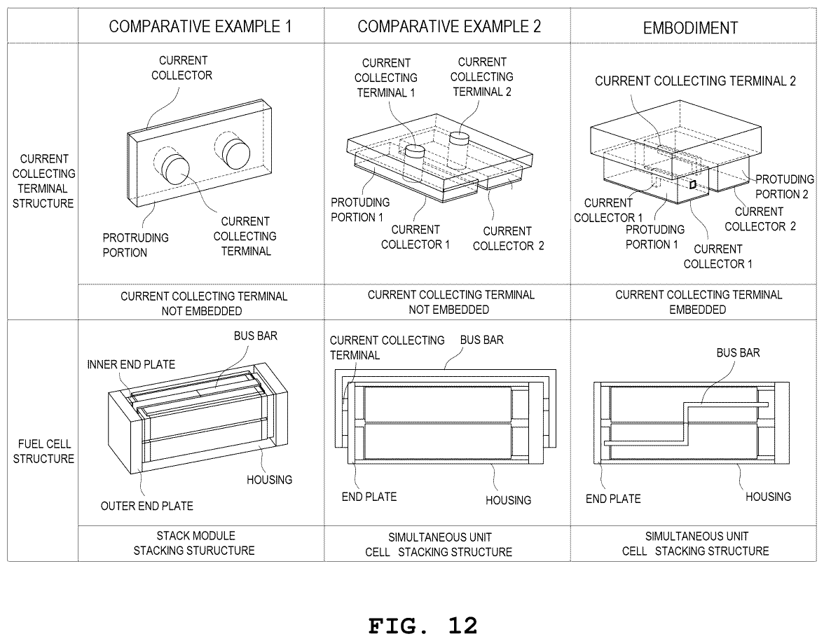

In addition, according to an embodiment of the present disclosure, because the current collecting terminals are embedded in the first end plate and the second end plate, the bus bar 600 may be mounted in the housing. Hereinafter, the structures of the current collecting terminals and the fuel cells according to the first and second comparative examples and an embodiment of the present disclosure are described with reference to FIG. 12. Referring to FIG. 12, the first comparative example is structured such that the outer end plates are coupled to the outer sides of the plurality of stack modules. Thus, although the current collecting terminals connected to the current collectors between the inner end plates and the cell stacks perpendicularly penetrate the inner end plates, the housing is coupled to the outer end plates, and the bus bar interconnecting the opposite current collecting terminals is located between the inner end plates and the outer end plates. Therefore, the bus bar may be located in the housing.

The second comparative example has the same current collecting terminal structure as the first comparative example (the structure in which the current collecting terminals penetrate the end plates perpendicularly to the current collectors), but employs a structure in which the inner end plates are eliminated and a plurality of unit cells is simultaneously stacked, like an embodiment of the present disclosure. In such a second comparative example, the bus bar is mounted outside the first end plate and the second end plate, and thus is not capable of being located in the housing. If the bus bar, which is a high-voltage part, is exposed to the outside, a safety incident may occur, and the fuel cell may be vulnerable to the surrounding environment.

In contrast, in the fuel cell according to an embodiment of the present disclosure, the current collecting terminals are embedded in the first end plate and the second end plate, and thus the bus bar 600 interconnecting the current collecting terminals is capable of being located in the housing. Accordingly, it is possible to solve the problems with the second comparative example, i.e., the safety incident problem and the vulnerability problem.

As described above, the fuel cell 10 according to an embodiment has an improved structure in which the fastening bar is coupled to the end plate and unit cells are directly stacked on the end plate, whereby a multi-stage stack module is established without stacking a plurality of stack modules.

Accordingly, the risk of injury caused by stacking the plurality of stack modules, which are heavy, may be prevented, and additional peripheral parts for coupling the plurality of stack modules may be eliminated. As a result, the package may become compact, manufacturing costs may be curtailed, and a process time may be shortened.

Further, the fastening bar of the fuel cell 10 according to an embodiment may serve to guide stacking of the unit cells and may also serve as an impact beam that protects the cells from external impact. The alignment bar of the fuel cell according to an embodiment may finally align the cell stacks and may secure an insulation interval between the cells, thereby preventing short circuit between the cells.

Furthermore, in the fuel cell 10 according to an embodiment, because the current collecting terminals are embedded in the end plates, all electrical parts are capable of being provided in the housing, thereby preventing the occurrence of a safety incident due to exposure of high-voltage parts to the outside.

As is apparent from the above description, according to a fuel cell according to an embodiment, a fastening bar may be coupled to an end plate, and unit cells may be directly stacked on the end plate, whereby a multi-stage stack module may be established without stacking a plurality of stack modules.

Accordingly, it is possible to prevent the risk of injury due to stacking of stack modules, which are heavy, and to eliminate additional peripheral parts for coupling the plurality of stack modules, thereby reducing the size of the package, curtailing manufacturing costs, and shortening a process time.

In addition, the fastening bar may serve as a guide when the unit cells are stacked and may also serve as an impact beam that protects the cells from external impact. An alignment bar may serve to finally align cell stacks and may also serve to secure an insulation interval between the cells, thereby preventing short circuit between the cells.

In addition, current collecting terminals may be embedded in the end plates, and thus all electrical parts may be provided in a housing, whereby the occurrence of a safety incident due to exposure of high-voltage parts to the outside may be prevented.

However, the effects achievable through the disclosure are not limited to the above-mentioned effects, and other effects not mentioned herein should be clearly understood by those skilled in the art from the above description.

Although only a limited number of embodiments have been described above, various other embodiments are possible. The technical contents of the above-described embodiments may be combined into various forms as long as they are not incompatible with one another, and thus may be implemented in new embodiments.

It should be apparent to those skilled in the art that various changes in form and details may be made without departing from the spirit and essential characteristics of the disclosure set forth herein. Accordingly, the above detailed description is not intended to be construed to limit the disclosure in all aspects and to be considered by way of example. The scope of the disclosure should be determined by reasonable interpretation of the appended claims and all equivalent modifications made without departing from the disclosure should be included in the following claims.

What is claimed is:

1. A fuel cell, comprising:
at least one cell stack including a plurality of unit cells stacked in a first direction;
a first end plate disposed on a first end of the at least one cell stack;
a second end plate disposed on a second end of the at least one cell stack;
at least one fastening bar fastened to at least one of the first end plate or the second end plate; and
a housing coupled to the first end plate and the second end plate and surrounding the at least one cell stack at a position outside the at least one fastening bar,
wherein the at least one cell stack includes a side portion having an accommodation groove formed by recessed portions included in the plurality of unit cells and extending in the first direction, and
wherein at least a portion of the at least one fastening bar is disposed in the accommodation groove.

2. The fuel cell according to claim 1, wherein the at least one fastening bar has a cross-sectional shape corresponding to a cross-sectional shape of the recessed portions.

3. The fuel cell according to claim 1, wherein the at least one fastening bar includes a plurality of fastening bars, and
wherein, among the plurality of fastening bars, a fastening bar located at a corner of the at least one cell stack includes a protection portion configured to cover the corner of the at least one cell stack.

4. The fuel cell according to claim 1, wherein the housing is coupled to at least a portion of the at least one fastening bar in a direction perpendicular to the first direction.

5. The fuel cell according to claim 1, wherein the at least one cell stack includes a plurality of cell stacks disposed in a direction perpendicular to the first direction, and
wherein the accommodation groove in each cell stack of the plurality of cell stacks includes:
an outer accommodation groove formed in an outer side portion of each cell stack of the plurality of cell stacks, the outer side portion facing the housing; and
an inner accommodation groove formed in an inner side portion of each cell stack of the plurality of cell stacks, the inner side portion facing a neighboring cell stack.

6. The fuel cell according to claim 5, wherein the at least one fastening bar includes:
at least one first fastening bar disposed in the outer accommodation groove; and
at least one second fastening bar disposed in the inner accommodation groove.

7. The fuel cell according to claim 6, wherein the at least one second fastening bar includes a plurality of second fastening bars, and
wherein the fuel cell further includes an alignment bar disposed between the plurality of second fastening bars and extended in the first direction between the first end plate and the second end plate.

8. The fuel cell according to claim 7, wherein a thickness of the alignment bar in a second direction is equal to or greater than a greatest interval between a cell stack of the plurality of cell stacks and an adjacent cell stack of the plurality of cell stacks.

9. The fuel cell according to claim 7, wherein the alignment bar includes:
an end portion coupled to at least one of the first end plate or the second end plate; and
another end portion having a tapered cross-sectional shape.

10. The fuel cell according to claim 1, further comprising:
a first current collector disposed between one of the first end or the second end of the at least one cell stack and the first end plate;
a second current collector disposed between another of the first end or the second end of the at least one cell stack and the second end plate;
a first current collecting terminal electrically connected to the first current collector and embedded in the first end plate; and
a second current collecting terminal electrically connected to the second current collector and embedded in the second end plate.

11. The fuel cell according to claim 10, wherein the first end plate includes:
a first body; and
a first protruding portion protruding from the first body toward the at least one cell stack,
wherein the second end plate includes:
a second body; and
a second protruding portion protruding from the second body toward the at least one cell stack,
wherein the first current collecting terminal is embedded in the first protruding portion, and
wherein the second current collecting terminal is embedded in the second protruding portion.

12. The fuel cell according to claim 11, wherein a protruding thickness of at least one of the first protruding portion or the second protruding portion is determined based on internal pressure of the at least one cell stack.

13. The fuel cell according to claim 10, further comprising:
a bus bar disposed in the housing and interconnecting the first current collecting terminal and the second current collecting terminal.

14. The fuel cell according to claim 13, wherein the at least one cell stack includes a plurality of cell stacks, and
wherein the bus bar connects the first current collecting terminal connected to one cell stack of the plurality of cell stacks, and the second current collecting terminal connected to another cell stack of the plurality of cell stacks.

15. A fuel cell, comprising:
a plurality of cell stacks disposed in a direction perpendicular to a first direction, wherein each of the plurality of cell stacks include a plurality of unit cells stacked in the first direction,
a first end plate disposed on a first end of the plurality of cell stacks;
a second end plate disposed on a second end of the plurality of cell stacks;
a first current collector disposed between a first end of the each of the plurality of cell stacks and the first end plate;
a second current collector disposed between a second end of the each of the plurality of cell stack and the second end plate;
a first current collecting terminal electrically connected to the first current collector and embedded in the first end plate;
and a second current collecting terminal electrically connected to the second current collector and embedded in the second end plate.

16. The fuel cell according to claim 15, wherein the first end plate includes:
a first body; and
a first protruding portion protruding from the first body toward the at least one cell stack,
wherein the second end plate includes:
a second body; and
a second protruding portion protruding from the second body toward the at least one cell stack,
wherein the first current collecting terminal is embedded in the first protruding portion, and
wherein the second current collecting terminal is embedded in the second protruding portion.

17. The fuel cell according to claim 16, wherein a protruding thickness of at least one of the first protruding portion or the second protruding portion is determined based on internal pressure of the at least one cell stack.

18. The fuel cell according to claim 15, further comprising:
a bus bar disposed in the housing and interconnecting the first current collecting terminal and the second current collecting terminal.

19. The fuel cell according to claim 18, wherein the bus bar connects the first current collecting terminal connected to one cell stack of the plurality of cell stacks, and the second current collecting terminal connected to another cell stack of the plurality of cell stacks.

20. A method of manufacturing the fuel cell of claim 7, the method comprising:
fastening the at least one fastening bar to the first end plate;
stacking the plurality of cell stacks on an inner side of the first end plate;
coupling the alignment bar to the second end plate;
inserting the alignment bar in an area between the plurality of cell stacks; and
coupling the second end plate to the fastening bar.
